(19) United States
(12) Patent Application Publication
(10) Pub. No.: US 2013/0289899 A1
(43) Pub. Date: Oct. 31, 2013

(54) REMOTE SENSING OF HYDROCARBON LEAKS

(71) Applicants: Boyd T Tolton, Edmonton (CA); Douglas W. Miller, Saskatoon (CA); Adrian Banica, Edmonton (AB)

(72) Inventors: Boyd T Tolton, Edmonton (CA); Douglas W. Miller, Saskatoon (CA); Adrian Banica, Edmonton (AB)

(73) Assignee: SYNODON INC., Edmonton (CA)

(21) Appl. No.: 13/872,988

(22) Filed: Apr. 29, 2013

Related U.S. Application Data
(60) Provisional application No. 61/639,258, filed on Apr. 27, 2012.

(51) Int. Cl. G01M 3/00

(52) U.S. Cl. CPC G01M 3/00
USPC 702/51

(57) ABSTRACT

A gas filter correlation radiometer mounted on an aircraft is flown over a target area. The gas filter correlation radiometer is configured to detect a gas in a vapour plume in the event of a liquid leak. The gas filter correlation radiometer uses a gas in the vapour or a gas that has a spectral band overlapping a spectral band of the vapour. The gas filter correlation radiometer uses background radiation to detect the vapour.

### CROSS-REFERENCE TO OTHER APPLICATIONS

This application claims the benefit under 35 USC 119(e) of United States provisional application US 61/639,258 filed Apr. 27, 2012.

### FIELD

Remote sensing of liquid leaks.

### BACKGROUND

This invention relates to remote sensing techniques to detect hydrocarbon leaks. In particular, the invention involves flying an aircraft with a remote sensing instrument over a target area, such as a pipeline, and measuring absorption of upwelling electromagnetic radiation that has passed through hydrocarbon vapour.

Past attempts to remotely detect natural gas leaks have involved detecting increased concentrations of methane (CH₄). CH₄ comprises approximately 95% of the composition of natural gas, which makes it a natural target for detection. One problem that has been experienced is that CH₄ exists in fairly large quantities in the atmosphere (it is well mixed in the atmosphere with a concentration of approximately 1.7 ppm). Therefore, detecting a gas leak required detection of a small increase on a large background. Events such as passing near a source region of CH₄ (such as a farm), or an increase in the altitude of the airplane (an increase in the atmospheric path length) might result in the false signature of a leak.

To reduce the influence of the background, some past attempts have tried to detect the excess CH₄ of a natural gas leak by detecting the absorption of CH₄ in the long wavelength infrared region (for example, at 7.8 μm or 2180 cm⁻¹). This provides the advantage that the upwelling radiation is primarily emitted from the earth's surface. This minimises the background CH₄, as only the CH₄ located between the airplane and the earth's surface is detected.

However, for underground pipe since the temperature of the surface and the leaked CH₄ are nearly the same, the radiative contrast between the surface and the leaked methane is very small, greatly reducing the detectivity/detectability of the leak. Also, the thermal noise introduced within the instrument itself becomes a serious design constraint. Using a shorter wavelength absorption band of CH₄ could potentially help, as the upwelling radiation would be primarily from the sun. This would greatly increase the radiative contrast between the source and the “leaked” gas, and significantly reduce the thermal noise within the instrument. However, the background of CH₄ becomes very large, as the solar radiation reaching the instrument would have passed through entire atmosphere.

### SUMMARY

According to an aspect of the invention, leaks of hydrocarbon liquid are detected by remote detection of radiation that has passed through a concentration of vapour of the hydrocarbon liquid.

According to a further aspect of the invention, the remote detection of radiation that has passed through a concentration of vapour of the hydrocarbon liquid is done by a gas filter correlation radiometer, the gas filter correlation radiometer having a gas correlation cell containing a gas having a spectral band overlapping a spectral band of a vapour of the liquid.

According to a further aspect of the invention, the gas contained in the gas correlation cell is ethane.

According to a further aspect of the invention, the spectral band of the vapour of the liquid is a spectral band of pentane.

According to a further aspect of the invention, the remote detection of radiation that has passed through a concentration of vapour of the hydrocarbon liquid is done by a gas filter correlation radiometer, the gas filter correlation radiometer having a gas correlation cell containing a gas present in the vapour of the liquid.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which:

FIG. 1 is a schematic of the gas filter correlation radiometer;

FIG. 2 is a schematic of an alternative embodiment of the gas filter correlation radiometer;

FIG. 3 depicts a helicopter using the gas filter correlation radiometer to detect a leak in a pipeline;

FIG. 4 depicts an overhead view of a helicopter traversing a pipeline and shows successive fields of view, including an exploded view of a portion of a field of view being sampled;

FIG. 5 shows, upper graph, a spectra of C₂H₆ in a 28.6 mm gas cell with 106 Pa of pure C₂H₆, middle graph, a high resolution spectra of C₂H₆ in a 28.6 mm gas cell with 12.1 kPa of pure C₂H₆ and, lower graph, a calculation of the spectra using the Hitran line database;

FIG. 6 shows the transmission of 100 ppm-m or pentane and methanol as a function of wavenumber in the 2700 to 3300 cm-1 region. Also shown is the passband of the realSens instrument; and

FIG. 7 shows the estimated ΔD2A signal from the realSens™ instrument passing over a 4′×8′×3″ pool of leaked WTI2 oil, gasoline, condensate or pure pentane, as a function of the time that the pool of liquid has been open to evaporation

### DETAILED DESCRIPTION OF PREFERRED EMBODIMENTS

In this patent document, the word “comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless the context clearly requires that there be one and only one of the elements.

The instrument used in this invention is a type of gas-filter correlation radiometer (GFCR). GFCRs have been used in different configurations for over 3 decades in remote sensing instrumentation.

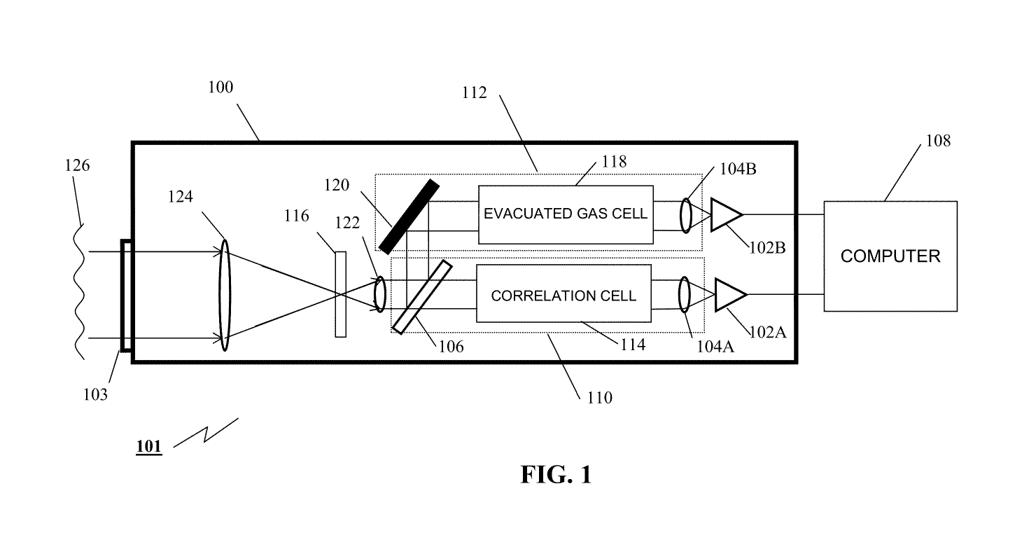

Referring to FIG. 1, there is shown a GFCR 101 incorporated within a housing 100, with a detector section, such as a pair of photodiode arrays 102A, 102B mounted in the housing. Radiation from source 126 passes through a window 103 in the housing 100, is collected by collector optic 124 and filtered by bandpass filter 116 and then directed by collimating lens 122 onto beam splitter 106. In an exemplary embodiment, a 40 cm⁻¹ wide band-pass filter 116 centred at 2988 cm⁻¹ is specified. The filter width is 1.3% of the central wavenumber. The passband of filter 116 is selected to include the ethane absorption peak at 3000 cm⁻¹ and exclude radiation falling outside of the peak. Beam splitter 106 formed by a partially reflective mirror splits the radiation from the radiation source 126 along paths 110 and 112. On the first radiation path 110, the radiation passes through gas correlation cell 114 and is focused by detector lens 104A onto the photodiode 102A. On the second radiation path 112, the radiation is directed by mirror 120 through an evacuated gas cell 118 and is focused by lens 104B onto photodiode 102B. The gas correlation cell 114, also called a gas filter or absorption cell, contains a gas, such as ethane, to be detected.

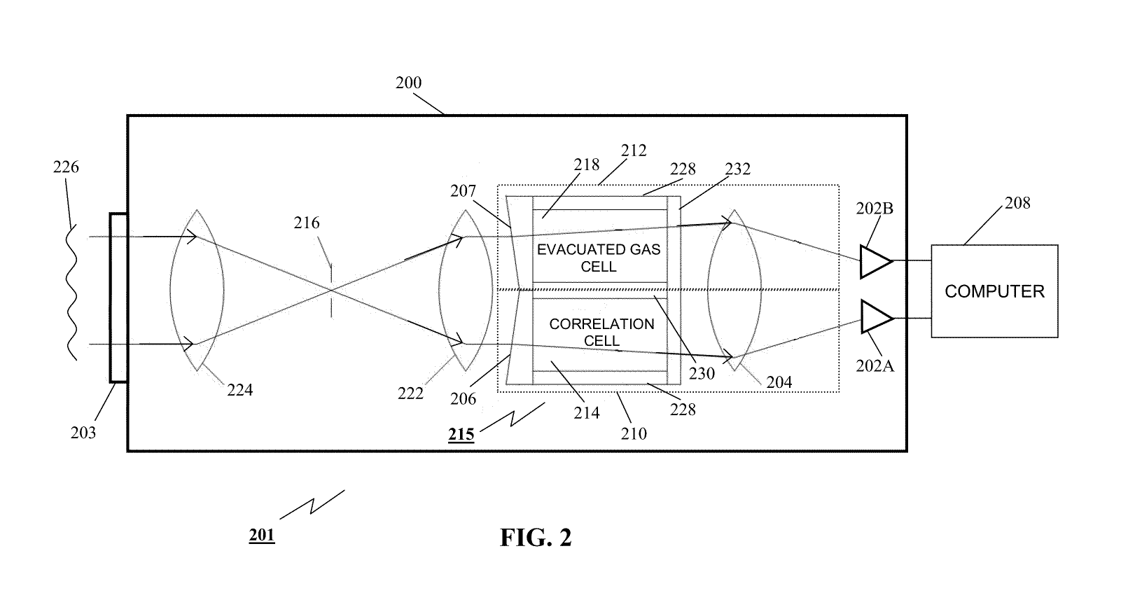

The gas correlation cell 114 may for example be a 1 cm cell with for example a concentration of ethane provided by one atmosphere of pure C₂H₆. The second path 112 has a different path length of C₂H₆, such as may be obtained by providing the cell 118 with for example no C₂H₆, as for example an evacuated gas cell or a cell containing a gas that is optically neutral in relation to the ethane spectra of interest. The output of the photodiodes 102A, 102B is provided to suitable electronics, such as a computer 108, for processing. The GFCR 101 may use a beam splitter, for example, in the form of a partially reflective mirror as shown in FIG. 1, or in the form of a bi-prism, as shown in FIG. 2, or may selectively direct the incoming radiation through separate paths, in a time division manner, using for example a chopper. The use of a beam splitter versus a chopper is a trade-off between simultaneity of the two received signals and loss of signal intensity. A beam splitter, such as a partially reflective mirror or a bi-prism, is preferred for gas leak detection because it provides simultaneous measurement of both detector signals. This can be important because the signals are fast varying due to the forward motion of the helicopter and the variation in the reflective surface.

A different optical configuration is shown in an alternative embodiment in FIG. 2. Radiation from source 226 passes through a window 203 in housing 200, is collected on collector optic 224 and focused to a field stop 216. The field stop 216 is used to limit the field of view. The radiation from source 226 is then directed by collimating lens 222 onto prisms 206 and 207 which form the front of a compound gas cell 215 formed by gas cell walls 228, gas cell separator 230, and a plane parallel gas cell window 232. The prisms 206 and 207 split the radiation from the radiation source 226 along paths 210 and 212 by causing the radiation to diverge while passing through gas cells 214 and 218. On the first radiation path 210, the radiation is directed by prism 206 through gas correlation cell 214 and is focused by detector lens 204 onto the photodiode 202A. On the second radiation path 212, the radiation is directed by the prism 207 through an evacuated gas cell 218 and is focused by detector lens 204 onto photodiode 202B.

The compound gas cell 215 with prisms 206 and 207 may also be located between the field stop 216 and the collimating lens 222, or between the detector lens 204 and the photodiodes 202A and 202B. Likewise, the prisms 206 and 207 may be located at either the front of the compound gas cell 215 or at the back of the compound gas cell 215.

The gas correlation cell 214, also called a gas filter or absorption cell, contains a gas, such as ethane, to be detected. The gas correlation cell 214 may for example be a 1 cm cell with for example a concentration of ethane provided by one atmosphere of pure C2H6. The second path 212 has a different path length of C2H6, such as may be obtained by providing the cell 218 with for example no C2H6, as for example an evacuated gas cell or a cell containing a gas that is optically neutral in relation to the ethane spectra of interest. The output of the photodiodes 202A, 202B is provided to suitable electronics, such as computer 208, for processing.

The detector signal on the path 112 is:

$${S}_{1} = G {\int }_{{λ}_{1}}^{{λ}_{2}} {I}_{λ} {τ}_{filter} d λ$$

where I_{λ} is the intensity of the radiation from the radiation source 126, τ_{filter} is the transmissivity of the filter 116, λ₁ is the low pass of the filter 116, λ₂ is the high pass of the filter 116 and G is the gain of the photodiode 102B.

The detector signal on the path 110 is:

$${S}_{2} = G {\int }_{{λ}_{1}}^{{λ}_{2}} {I}_{λ} {τ}_{filter} {τ}_{corr . cell} d λ$$

where τ_{corr cell} is the transmissivity of the correlation cell 114.

If

$${S}_{avg} = \frac{{S}_{1} + {S}_{2}}{2}$$

and S_{diff}=S₁−S₂, then the calculation made by the computer is:

$${S}_{inst} = \frac{{S}_{diff}}{{S}_{avg}} ,$$

which yields a signal that is dependent on the presence of the target gas in the radiation path from the source 126 to the photodetector 102B. The calculation of the difference in the received signals for both optical paths is made for each pixel of the photodetectors 102A, 102B to yield an image of the field of view that may be displayed on a monitor.

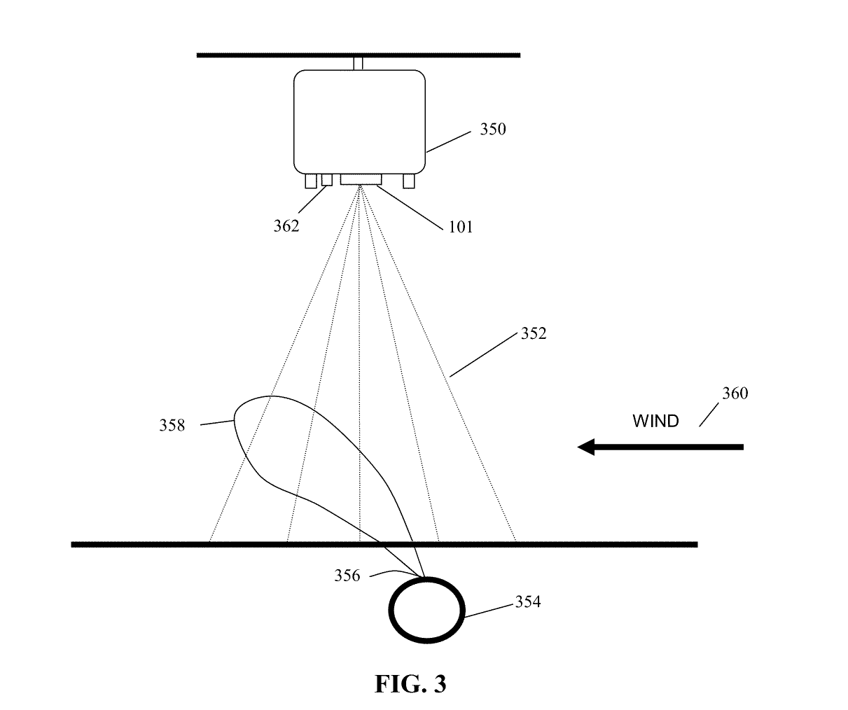

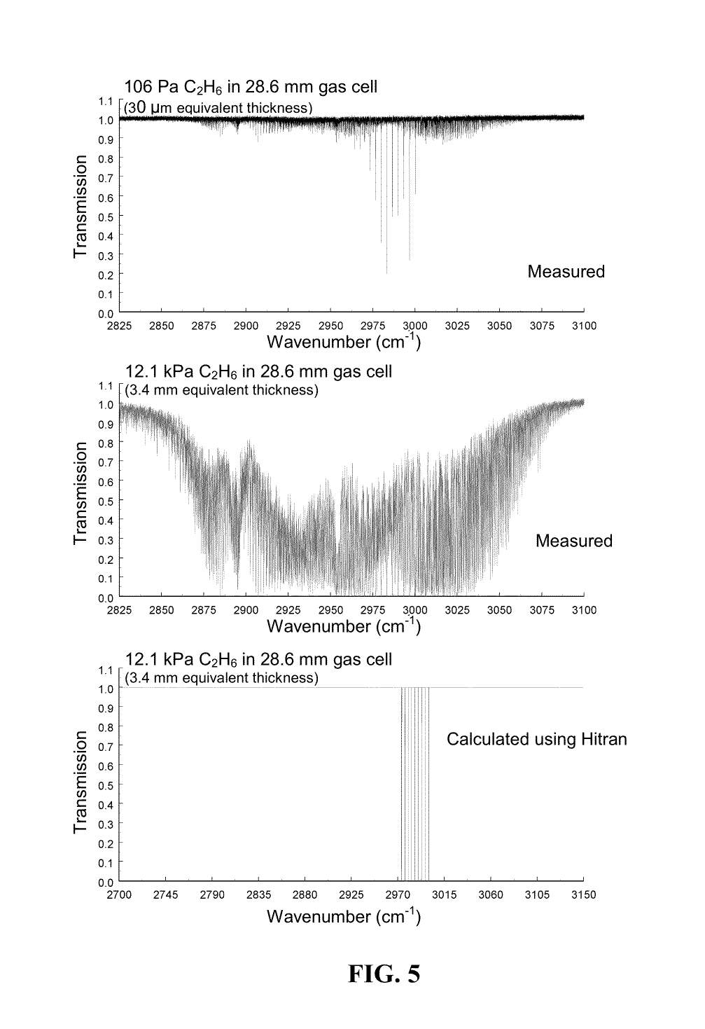

FIG. 3 shows the manner of use of the GFCR 101 shown in FIG. 1. A helicopter 350 traverses a pipeline 354 with a GFCR 101 having a field of view 352 oriented towards the pipeline 354. The GFCR 101 is tuned to detect ethane by appropriate selection of the bandpass of the filter 116, and the gas filter 114 contains a sample of ethane. If a leak 356 exists in the pipeline 354, the presence of ethane in the resulting plume 358 that may be moved by the presence of wind 360 will be detected using the GFCR 101. The presence of a leak is indicated by for example displaying the received signal using a monitor that is provided as part of the computer 108. Pixels on the monitor display corresponding to detected ethane may be coloured to enhance the image. Other methods of indication of the presence of a leak may be used such as detecting a concentration of ethane in the path between helicopter 350 and the ground that exceeds a predetermined threshold, and providing an alarm. The threshold is determined readily by calibration of the radiometer and experimentation. FIG. 5 shows that the absorption spectra of ethane at 3000⁻¹ cm is larger than the calculated spectrum from the Hitran database, with the result that ethane is unexpectedly a suitable candidate for the detection of pipeline gas leaks. Due to the remote sensing capabilities of the device, the GFCR does not have to fly through the plume in order to detect leaks. The GFCR measures the integrated column concentration of natural gas between the helicopter and the ground, regardless of where in this column the natural gas occurs.

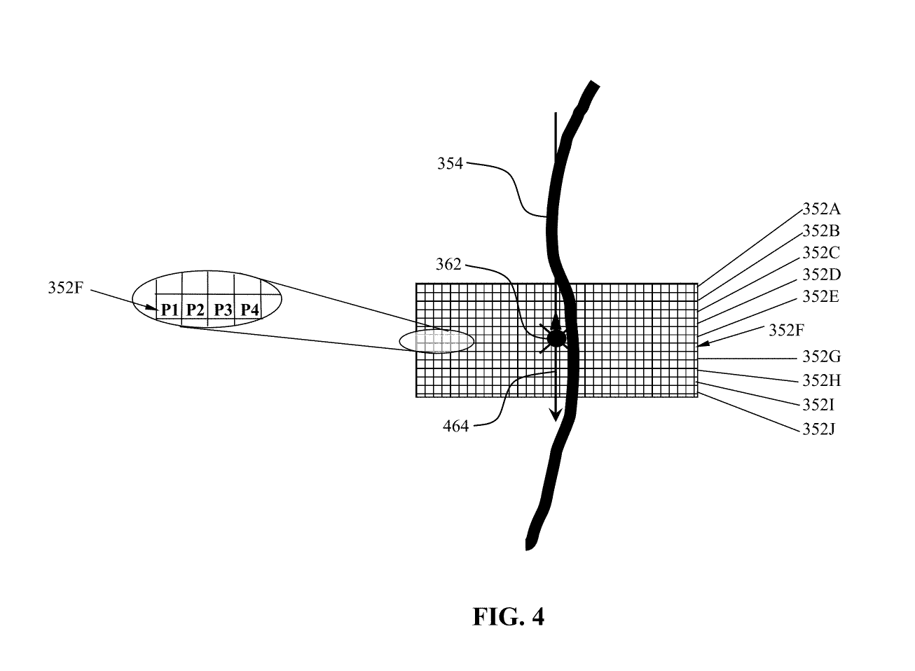

In one embodiment as shown in FIG. 4, the field of view 352 covers an area of 128 m², representing a swath 64 m long by 2 m wide. The long but narrow swath of the field of view 352 leads to an overall view of the pipeline 354 or target area through the use of a technique known as pushbroom imaging. As the helicopter 350 advances along the helicopter path 464 over the pipeline 354 or other target area, successive swaths below the helicopter 350 and perpendicular to the helicopter path 464 are detected by the GFCR 101. At a first time interval, the detectors 102A and 102B would sample signals from the field of view 352A, followed moments later by 352B, followed again by 352C and so on.

In FIG. 4, the field of view 352F represents the current swath of the target area being detected by the detectors 102A and 102B. Detectors 102A and 102B have corresponding pixels having collocated fields of view 352F where each 2 m×2 m cell of the field of view 352F is sampled synchronously by detectors 102A and 102B. Therefore, the cell marked P1 would be detected by a first pixel representing a portion of the field of view collocated and synchronized on detectors 102A and 102B. The cell marked P2 would be detected by a second pixel collocated and synchronized on detectors 102A and 102B. The same can be said for the cells marked P3 and P4 and so on. All cells P1 to P32 along a line would be detected simultaneously.

In an exemplary embodiment, the GFCR 101 operates using ambient background radiation that passes through the plume 358 of natural gas. The upwelling radiation field is comprised of reflected solar radiation, radiation emitted from the surface, plus upwelling emission from the atmosphere. For operation during cloudy periods or at night, a source of illumination 362 may be used. For example, a powerful 1600 W Tungsten Halogen bulb may be mounted on the helicopter 350, with an IR transmitting window (not shown) and a focusing mirror (not shown). This mirror focuses the emission from the illumination source 362 to a 5 m spot on the ground. Assuming a lambertian reflective surface and a reflectivity of 5%, the reflected intensity at the surface would be 0.048 W m⁻². This is roughly equivalent to (or slight greater than) the reflected intensity of sunlight. The illumination source 362 should be mounted to reduce vibrations that could increase the signal to noise ratio of the detected signal. In an alternative embodiment, the GFCR 101 may be mounted on a different type of vehicle, such as a truck, and driving the vehicle along a pipeline or other possible source of a gas leak. The GFCR 101 may also be tuned to detect other gases by selection of the bandpass of the filter 116.

The detected instrument signal is a function of the height of the natural gas column. For an atmospheric background concentration of 1 ppb of C₂H₆, the equivalent total atmospheric column thickness is approximately 8.5 μm. The equivalent CH₄ column thickness would be approximately 1700 times thicker.

A linear regression of the signal sensitivity between 0 and 4 mm of natural gas shows that the change in signal per mm of natural gas is −1.69×10⁻³ mm⁻¹. The measurement is actually detecting C₂H₆ which is assumed to be 2.5% of natural gas. Therefore, the detected columns of pure C₂H₆ are 40 times shorter than that of methane. Maximum sensitivity to C₂H₆ occurs at the lowest concentrations. This is the most desirable for detecting the smallest leaks.

Uncertainties may be introduced into the measurement by spectral interferences by other gases in the atmosphere (principally H₂O and CH₄), variations in the surface emissivity, temperature variations in the atmospheric temperature, and variations in the altitude of the airplane. These uncertainties tend to reduce the sensitivity of the measurement to concentrations of natural gas, and variations may result in false signatures of leaks. The combined uncertainty is about +/−19 μm. This level of accuracy places a minimum limitation on the measurement's accuracy. Given a measurement resolution of −1.69×10⁻³ per mm natural gas, to measure a column height of ±19 μm a measurement precision of ±3.2×10⁻⁵ (i.e. a signal-to-noise ratio of 31,000) is required. Such a measurement precision may be obtained from the GFCR 101, and may be adjusted by for example varying the length of the absorption cell 114.

The sensitivity of the instrument is ultimately a function of the amount of energy that is collected and focussed onto the detector element. This in turn is a function of the field-of-view (FOV) of the instrument (which determines the surface resolution), the size of the collector optic 124, the size of the detector pixel in the photodiodes 102A, 102B, the transmission of the instrument, and the observation period (frequency) of the instrument. The FOV and the collector optic size directly affect the energy collected, as the larger the optic and FOV, the more photons collected. However, they also directly affect the detector pixel size, due to the principle of etendue (AΩ) conservation in an optical chain. The transmission of the instrument directly affects the energy collected as any losses in the system directly reduces the number of photons incident on the detector. And finally, the pixel size and observation period directly affect the noise-equivalent power (NEP) of the detector. In an exemplary embodiment, the aircraft may operate at a height of 30 m, with surface resolution 1.5 m, FOV solid angle 2.0×10⁻³ sr, FOV 2.86°, collector optic diameter 12.2 cm, AΩ product 2.29×10⁻⁵ m² sr, transmission 75%, temperature 293K, observation time 10 ms (100 hz), detector element diameter 2 mm, detector FOV 170° and detector D*10¹¹ cm Hz^{0.5}.

The upwelling radiance reaching the aircraft is calculated to be 0.04 W m⁻² sr⁻¹. This includes the energy lost due to absorption by atmospheric H₂O and CH₄, and which is reduced to 0.03 W m-2 sr⁻¹. Assuming the instrument has a 12.2 cm diameter optic to collect upwelling radiation with a field-of-view of 2.86° and an instrument transmission of 75%, the collected energy by the instrument will be 5.2×10⁻⁷ W. The noise equivalent power (NEP) for a 2 mm diameter liquid nitrogen cooled InSb detector would be 2×10⁻¹¹ W, providing a radiative S/N ratio of approximately 25,800. Given this level of precision and the calculated sensitivity to natural gas of −1.69×10⁻³ mm⁻¹, the measurement is able to detect below a 23 μm column of natural gas.

To detect leaks from hydrocarbon liquids pipelines, the realSens technology disclosed above must be adapted in one of two ways. The first method is to make the realSens instrument sensitive to a specific chemical by putting the vapour of the chemical into the correlation cell(s) of the realSens radiometer. This requires choosing a chemical that is (1) present in the liquid mixture in a relatively high concentration, (2) has a high saturation vapour pressure, and (3) has a strong spectral band in the 3 μm region. The second method is to use an interference effect with a gas in the correlation cell which has a strong spectral band over-lapping a strong spectral band of a vapour of the liquid (or a combination of different chemicals in the liquids mixture). This has the advantage that there is little to no modification to the realSens instrument required. Also, if more than one chemical in the liquids mix which has a significant vapour pressure, all the gases can add to the effect.

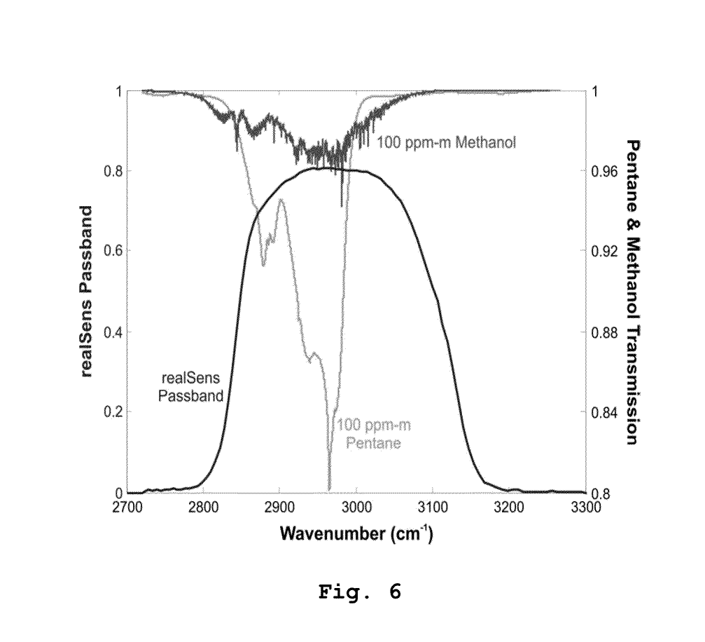

The interferences between both a C₂H₆ and CH₄ realSens instrument and the vapour phase of pentane and methanol were modelled. Pentane was chosen as it is a relatively high concentration component of light crude, natural gas condensates, and refined petroleum products. It is also has a strong spectral band in the 3 μm region, a high saturation vapour pressure (≈55 kPa at STP), a boiling point of 36° C., and is a relatively safe chemical (highly flammable, but non-carcinogenic and chemically stable). Methanol was chosen even though is it not in hydrocarbon liquids, but has a strong band in the 3 μm region, has a high vapour pressure (≈12 kPa at STP), and is very easy to purchase. FIG. 6 shows the absorption bands of 100 ppm-m of methanol and pentane in the 2700 to 3300 cm-1 region (≈3 μm). Also shown is the passband of realSens instrument.

The following terminology is used concerning signals in the realSens instrument: the COR signal is a signal measuring the light passing through a correlation cell (containing a gas, such as C₂H₆ or CH₄), the REF signal is a signal measuring the light that passed through a reference cell not containing any optically active gas, the DIFF signal represents the difference between the COR and REF signals, the AVG signal represents the average of the COR and REF signals, and the D2A signal represents the ratio of the DIFF and AVG signals.

The first simple test of GFCR interference by evaporated vapours of hydrocarbon liquids would be to place the realSens instrument over a source and have a gas cell filled with the vapour between the source and realSens. This model calculation was carried out for a CH₄ realSens and for a C₂H₆ realSens for both methanol and pentane. Both models assumed a 45° C. blackbody source.

Both pentane and methanol show relatively strong interference effects in both a CH₄ and C₂H₆ realSens. Pentane induces a very rapid change in D2A signal but levels off quickly. This is due to the spectral band of pentane (which is strong, see FIG. 6) saturating relatively quickly. Methanol, which has a weaker band, does not saturate as fast. For the CH₄ realSens, pentane has a stronger effect than methane itself for lower ppm-m, falling behind methane around 6000 ppm-m. Methanol has a smaller effect for lower ppm-m, but passes methane around 8000 ppm-m. For the C₂H₆ reakSens, pentane has a comparable or slightly higher effect to ethane at very low ppm-m but already falls behind ethane around 1000 ppm-m. Methanol has a much smaller effect than ethane at all concentrations but matches pentane around 10000 ppm-m.

Modelling of the sensitivity of realSens to interference by pentane and methanol in the lab suggests a strong interference effect. This section shows the results of full atmospheric models of a CH4 realSens.

The sensitivity of a CH4 realSens to leaks of pentane, methanol and CH4 in the atmosphere was modelled. Unlike the modelled sensitivity in the lab, the sensitivity to CH4 is significantly reduced relative to pentane and methanol. This is due to the fact that the atmosphere contains a significant quantity of CH4, reducing sensitivity to the any leaked gas. The sensitivity to interference by pentane and methanol is very similar to that in the lab.

Unfortunately, this analysis does not contain the full data processing for realSens. Specifically it does not include surface thermal (TH) correction. With this correction included in the model, for both pentane and methanol, TH surface correction effectively “kills” any interference signal in a CH4 realSens. This is due to the fact that any “leak” of pentane and methanol will cause a reduction in the upwelling radiance that will be indistinguishable from a change in the surface reflectivity (Rsurf). Also, the spectral absorption features are uncorrelated to the absorption lines of CH4.

The sensitivity of a CH4 realSens to a CH4 leak, was modelled both with and without TH surface correction. It shows that TH surface correction reduces sensitivity to leaked CH4. Although this result was initially a bit of a surprise, it does make sense, as any absorption due to a “leak” would be indistinguishable from a localised reduction in Rsurf.

This section shows the results of full atmospheric models of a C₂H₆ realSens. The sensitivity of a C₂H₆ realSens to a leak of pentane, methanol and C₂H₆ was modelled. The sensitivity to C₂H₆ is significantly reduced compared to the lab measurement (although is very strong compared to CH₄). This is likely due to absorption by water vapour and CH₄ in the atmosphere. The sensitivity to interference by pentane and methanol is very similar to that in the lab.

Again, the above analysis does not contain the full data processing for realSens in that it does not include surface thermal (TH) correction. The sensitivity of a C₂H₆ realSens to leaks of pentane, methanol and C₂H₆, with and without TH surface correction was modelled. All three show an increase in sensitivity to a leak with TH surface correction. This analysis has been quite instructive, and has provided a couple of significant surprise. To begin with, we knew that any gas which has a spectral absorption band in the spectral range of realSens would produce a signal, which we call “interference”. To first order, the absorption by this interfering gas will cause a reduction in the AVG signal without producing an equivalent reduction in the DIFF signal, therefore causing a change in the D2A signal.

This document detailed the results of a series of model calculations using GenARTS (General Atmospheric Radiative Transfer Simulator), a Synodon proprietary spectroscopic modelling software, to show the interference effects due to leaks of pentane and methanol on both a CH₄ and a C₂H₆ realSens. The sensitivity to leaks of pentane, methanol, CH₄ and C₂H₆ in the lab were found. The sensitivity of a CH₄ and a C₂H₆ realSens (respectively) to a full atmosphere measurement was also found. It was also shown how TH surface correction affects sensitivity to the leaks.

In the lab model, we saw that this interference effect caused by a leak of pentane and/or methanol in the lab produces a significant sensitivity to these gases. In the full atmosphere model, we also saw similar sensitivities. However, once TH surface correction was performed on a CH₄ realSens, sensitivity to pentane and methanol essentially disappeared. This was not the case with a C₂H₆ realSens.

The process of TH surface correction was developed to reduce noise due to (often observed) large surface temperature (Tsurf) variations. It involves comparing the measured REF signal to a look-up-table of GenARTS modelled REF signals to retrieve an average Rsurf. Using this retrieved Rsurf, a measurement of the Tsurf, and the GenARTS model, both the REF and COR are adjusted to normalise these signals to a nominal or average Tsurf. This process has been successfully employed in our current realSens analysis.

The presence of a “leak” of a gas with a spectral absorption band in the realSens pass band will result in a lower retrieved Rsurf. This is because the analysis cannot tell the difference between a reduction in Rsurf or absorption by a gas not in the GenARTS model of the atmosphere (ie. a “leak”). The TH correction will then adjust REF and COR assuming that the reduced radiance was caused by a reduced Rsurf. For a leak of the correlation gas (either CH₄ or C₂H₆), the REF signal is reduced, but to first order the COR signal is unaffected; thus sensitivity to these gases remains. For a leak of an interfering gas/vapour, both REF and COR signals are affected; thus TH correction reduces the interference effects by the gas/vapour. In the case of a CH₄ realSens, which has a very distinct line spectra, TH correction essentially “kills” the interference effects.

In the case of a C₂H₆ realSens, which has a not-so-distinct line spectra (a broad absorption feature), the interference effects are actually enhanced by TH correction.

This short note provides estimates of the evaporation rates of liquids from a hydrocarbon liquids target. The target was assumed to be a 4′×8′×3″ pool of liquid (226.5 L). Data for composition of crude oil and gasoline from Appendix 6A, Composition of Crude Oil and Refined Products, London Partners Pipeline LLP, US EPA available on the internet.

Evaporation rates were calculated using an EPA formula for estimating evaporation rates from spilled liquids as published in “Risk Management Program Guidance for Offsite Consequence Analysis, USEPA, 550-B-99-009, March 2009, available on the internet for example.

Evaporation rates for individual chemicals in a liquid mixture were calculated by multiplying the evaporation rate of the pure chemical by the volume mixing ratio of the chemical in the mixture. Also, only the chemicals modelled were assume to be evaporating. Therefore, as the pool evaporates, the estimated evaporation rates will be low. However, this model assumes that the mixing ratio of the evaporating chemicals at the surface of the pool will be the same as in the pool. Since this is unlikely to be the case, this will cause an overestimate in evaporation rates.

The model assumed a 4′×8′ target (pool of liquid), 3″ deep, comprising 226.5 L of hydrocarbon liquid. Other assumptions included a temperature of 25° C., and a wind speed of 2 m/s (7.2 km/hr).

WTI2 contains 0.40% isobutane, 1.91% butane, 1.27% isopentane, and 1.95% pentane (by volume, totalling 5.53%).

Gasoline is a light hydrocarbons mixture. Numerous chemicals in gasoline have significant vapour pressures, and evaporate quickly. These include: butane, pentane, hexane, heptane, 2,3-dimethylbutane, isopentane, 2-methylpentane, 3-methylpentane, 2,2,4-trimethylpentane, 3-methylhexane, 2-methyl-2-butene, benzene, toluene, and MTBE, representing 62.9% (by volume) of total gasoline composition. Ethanol is a frequent additive to gasoline, up to 10%. As such, its evaporation rate was calculated. However, ethanol was not included in complete gasoline model.

Natural gas condensate is also a light hydrocarbons mixture. Numerous chemicals have significant vapour pressures, and therefore evaporate quickly. These include: butane, isobutane, pentane, isopentane, hexane, neohexane, benzene, cyclohexane, 2,2,4-trimethylpentane and toluene. These 10 chemicals represent 66.5% by volume of the composition of condensate.

Pentane is a principle component of light hydrocarbon liquids such as gasoline and condensate, and has a high vapour pressure. As such it is one of the principle chemicals detected by the liquids realSens™. The evaporation rate of a pool of pure pentane will remain constant until the pool is completely evaporated. For the given model, the evaporation rate for pentane is 4.12 lpm (liquid). The pool of pentane completely evaporates in ≈55 minutes, assuming a wind of 2 m/s and a temperature of 25° C.

The evaporation model was applied to WTI2, gasoline, condensate and pentane, estimating the evaporation rates over time for a pool of the leaked liquid. The next step in the modelling is to consider estimate how the evaporated plume will effect realSens™ signals. Consider that as the liquids evaporate, the amount of liquid in the air above the leak is dependent on the wind speed. As the liquid evaporate into the volume of air above the liquid leak, it is blown away from the source. Since the FOV of realSens™ on the ground is approximately 2 m, the time (t) for the volume of air to move 2 m is: t=2/U , where U is the wind speed. Since the modelled evaporation rate is proportional to U^{0.78}, the amount of evaporated liquid in the volume of air will be proportional to U^{-0.22}. This means that the slower the wind speed, the more evaporated gas in FOV.

Note that this is a very simplistic model. Most mixing in the atmosphere, especially near the surface and over short time scales is primarily by turbulence. As such, pockets of high concentration will be observed.

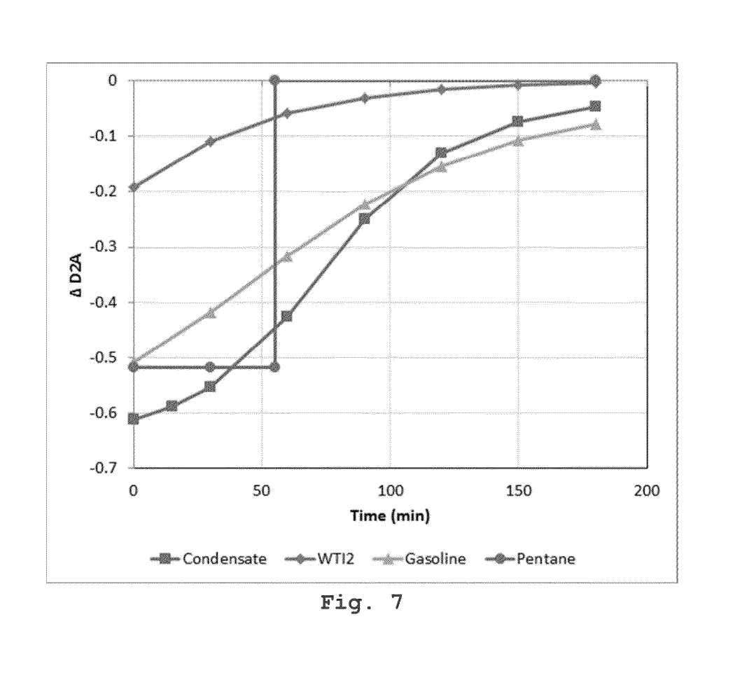

FIG. 7 shows the estimated ΔD2A signal from the realSens™ instrument passing over a 4′×8′×3″ pool of leaked WTI2 oil, gasoline, condensate and pure pentane, as a function of the time that the pool of liquid has been open to evaporation. The model assumes a wind speed of 2 m/s (7.2 km/hr) and a temperature of 25° C. The realSens™ “leak” signature decreases with time, as the light components of the liquid evaporate away. The maximum ΔD2A signals for WTI2 oil, gasoline, condensate and pentane were −0.191, −0.507, −0.612 and −0.517, respectively. All should be easily detectable.

The results of a series of model calculations which attempted to determine if it is possible for realSens™ to detect evaporative plumes of evaporated vapours coming off a 4′×8′×3″ pool of oil, gasoline, condensate and pentane, were detailed above. The first part of this modelling effort was to determine how quickly different chemicals in the four hydrocarbon liquids evaporate over time. The second part detailed the results of calculations of the expected ΔD2A resulting from realSens™ passing over the pool, as a function of the time that the liquids have been in the pool.

For oil, only 4 chemicals were modelled (butane, isobutane, pentane and isopentane). FIG. 7 (diamonds) shows the estimated ΔD2A signal over time caused by the four chemicals. The maximum ΔD2A (magnitude) was −0.191.

For gasoline, only 14 chemicals were modelled, comprising 62.9% of the volumetric composition of gasoline. For some chemicals, such as MTBE, the evaporation rate increases before it decreases. This is due to the fact that faster evaporating chemicals in gasoline initially increase the concentration of MTBE in the pool of gasoline. FIG. 7 (triangles) shows the estimated ΔD2A signal over time for gasoline, with the maximum ΔD2A (magnitude) was −0.507.

For condensate, 10 chemicals were modelled, comprising 66.5% of the volumetric composition of condensate. Similarly to gasoline, the rates of evaporation of some of the heavier chemicals increase at the beginning FIG. 7 (squares) shows the estimated ΔD2A signal over time for gasoline, with the maximum ΔD2A (magnitude) was −0.612.

Finally, pure pentane was modelled, with the evaporation rate being 4.12 lpm (liquid). FIG. 7 (circles) shows the estimated ΔD2A signal over time for pentane, being −0.517 until pentane all evaporates in 55 minutes.

The ΔD2A signatures for all hydrocarbon liquids tested should be relatively easy to detect. However, there are so many assumptions made in the analysis that it is very hard to even estimate the accuracy, let alone validity, of these results. But the results are very encouraging.

Synodon Inc. has developed a remote sensing technology to detect emissions from hydrocarbon liquids, based on its realSens™ natural gas leak detection technology. This solution has been previously demonstrated for the airborne detection of vapours from gasoline and pure pentane leaks, and has now been shown capable of detecting leaks of natural gas condensates.

On the afternoon of Sep. 12, 2012, Synodon performed a series of measurements to determine the sensitivity of the liquids realSens™ to condensate vapours. The test flights were performed 65 km west of Calgary over two representative surfaces, a partially over-grown gravel surface and a grassy surface. The measurements were performed at the request of Keyera Corp., who provided to Synodon a sample of fresh sweet condensate. The environmental conditions at the time of the tests were typical for a normal summer day, mainly clear and 21° C. It was however quite windy, with sustained winds of 20 km/h, gusting to >35 km/h.

In order to ensure that a known and controlled amount of vapours are released during the test, Synodon developed a custom system evaporator which consisted of a sealed pressure tank filled with the sample condensate. Compressed nitrogen gas was bubbled at various rates through the condensate in the tank. At the exit port of the tank, a 15 m length of hose guided the stream of nitrogen gas and condensate vapour to a downwind release point. To measure the amount of condensate evaporated with each release cycle, the evaporator was suspended from a weight scale, and the flow rate of nitrogen was set using a rotameter.

In total, 9 overflight passes were performed over the gravel leak site and 8 more over the grass leak site. Condensate evaporation rates ranged from 47 to 291 ml/min of equivalent liquid. Of the 17 overflight passes, condensate vapours were detected in 16 passes (94%), including the lowest condensate evaporation rate tested. An example of one condensate leak detection, taken on the 5^{th} pass of the grass leak site, corresponded to a condensate leak rate of 140 ml/min. In the example the plume seemed to be “chopped up”, with three main “blobs”. This is commonly seen in gas plumes on windy days as the turbulence chops up the plume dynamics.

This study has clearly demonstrated that the liquids realSens™ instrument can remotely detect ground-level gas plumes of evaporated natural gas condensates.

Since 2009, Synodon Inc. has been offering airborne remote sensing leak detection services known as realSens™ to the natural gas pipeline industry. In 2012, Synodon has undertaken research into the potential for adapting the realSens™ technology for the detection of leaks from hydrocarbon liquids pipelines. This research has included numerical modelling, lab experiments, ground-based plume measurements of pentane, and flight leak detection tests for pentane and gasoline. This document details the results of a third flight test of a hydrocarbon liquids realSens™, this time testing with natural gas condensate.

Condensate is a low-density mixture of light hydrocarbons (C5+) liquids that are present as gaseous components in the raw natural gas produced from many natural gas fields. It condenses out of the raw gas if the temperature is reduced to below the hydrocarbon dew point temperature of the raw gas. Its main components are typically pentane and iso-pentane (typically 30% to 60%). Given that Synodon has already demonstrated detections of pure pentane and gasoline vapour plumes, we fully expected to detect condensate vapour plumes.

A hydrocarbon liquids realSens™ does not remotely sense the presence of liquid hydrocarbons, but rather it detects the gaseous vapours which evaporate off the liquids. As such, a hydrocarbon liquids realSens™ is best suited at detecting lighter liquids which have a high vapour pressure (evaporate easily). Heavier liquids with lower vapour pressures will be harder to detect. However, all liquid hydrocarbons starting from raw petroleum as well as the majority of the products derived from it contain a certain percentage of light hydrocarbon (also called ‘light ends’). West Texas Crude Intermediate oil is composed of roughly 5-10% light ends while products such as gasoline contains over 20% light ends. Another potential target product is diluted bitumen or ‘dilbit’. In order to enable transportation through a pipeline, oilsands bitumen or heavy oils must be diluted, often with condensate. When a leak in a diluted bitumen (dilbit) pipeline happens, the condensate diluent quickly evaporates leaving the heavy bitumen to clean up. Both the proposed Keystone XL and Northern Gateway pipelines will be dilbit lines.

To determine the ability of the realSens™ technology to detect leaks of condensate, Synodon was requested to perform an airborne leak detection test by Keyera Corp., an Alberta-based midstream natural gas and natural gas liquids company. The company provided to Synodon a 5 gallon sample of fresh sweet condensate. The leak tests were performed on Sep. 13, 2012.

The condensate leak tests were performed 65 km west of Calgary near the intersection of highway 1 & 40. The location was selected as it was remote from any populated areas, presented a safe location for the atmospheric release of condensate vapours and was near the hangar of the helicopter supplier. The site also had two representative surfaces over which to perform the test. The first location was a “gravel” site, consisting of a partially over-grown gravelly surface, similar to an oilfield or pipeline facility pad (51.10801° N, 115.00681° W). The second location was a “grass” site, consisting of a fully grass covered cow/horse pasture (51.10677° N, 115.00715° W).

The condensate leak tests were performed on Sep. 13, 2012, between 14:00 and 14:45. The environmental conditions at the time are shown in table 1:

TABLE 1

| | |
|---|---|
| Temperature: | 21° C. |
| Absolute Pressure: | 87.7 kPa |
| Relative Humidity: | 22% |
| Surface | 25° C. (average) |
| Temperature: | |
| Clouds: | mainly clear |
| Wind: | 20 km/h (gusts to 35) |
| Wind Direction: | 250° (from WSW) |

Note that the winds were quite high. The location of the test site was the Bow river valley, on the lee side of the Rocky Mountains. This location often has high winds, and the day of the tests was no exception. High winds produce high turbulence in the plume dynamics, often making detection more difficult due to the plume diffusion and the detected plumes look more discontinuous than usual.

Condensate, when exposed to the atmosphere, will evaporate quite quickly due to the high concentration of light hydrocarbons. However, the evaporation rate and the amount of vapours in a subsequent plume are highly variable and very dependent on wind, atmospheric pressure and temperature. This creates a lot of uncertainty in the detection process which would make it very hard to draw firm decisions about the capabilities of any technology to detect condensate leaks under other conditions. To get around this problem, an evaporator system was devised to produce a plume of condensate vapours and to allow for a deterministic an evaporation/leak rate.

The evaporator consisted of a standard 10 litre pressure paint tank. In the evaporator configuration, the tank was filled with condensate while pressurised nitrogen (N₂) gas was blown through the condensate from the bottom of the tank. The N₂ bubbled up though the condensate, evaporating it. At the exit port of the tank, a 15 m length of hose guided the stream of N₂ gas and condensate vapour to a downwind release point. To determine the rate of condensate evaporation from the system, the tank was suspended from a digital weight scale, and the flow rate of N₂ was measured using a rotameter. The weight of the tank system together with the liquid condensate within it could be determined to an accuracy of 10 g. Section 2.6 describes how evaporation rates were calculated.

The following section details the results of each overflight pass over the gravel leak site by the realSens™ instrument. In total, there were 9 passes over this site, with different N₂ flow rates through the evaporator (therefore different evaporation rates). Table 2 lists the results of this test:

TABLE 2
Results of Each Pass of the Gravel Leak Site

| | | N₂ Flow | Condensate | |
|---|---|---|---|---|
| | | Rate | Evaporation Rate | |
| Pass # | Time | (scfh) | (lpm, liquid) | Detected |
| 1 | 14:00 | 300 | 0.141 | no |
| 2 | 14:01 | 400 | 0.188 | yes |
| 3 | 14:02 | 400 | 0.188 | yes |
| 4 | 14:04 | 540 | 0.253 | yes |
| 5 | 14:05 | 400 | 0.188 | yes |
| 6 | 14:06 | 200 | 0.094 | yes |
| 7 | 14:07 | 500 | 0.235 | yes |
| 8 | 14:09 | 500 | 0.235 | yes |
| 9 | 14:10 | 500 | 0.235 | yes |

The condensate leak plumes were detected on every pass except one. The pass that no condensate plume was detected was the second lowest condensate evaporation rate.

For gravel site pass #1, no condensate vapour is detected. For gravel site pass #2, a very strong condensate vapour plume is detected. For gravel site pass #3, a strong condensate vapour plume is detected. For gravel site pass #4, a strong condensate vapour plume is detected. For gravel site pass #5, a strong condensate vapour plume is detected. For gravel site pass #6, a strong condensate vapour plume is detected. For gravel site pass #7, a strong condensate vapour plume is detected. For gravel site pass #8, a strong condensate vapour plume is detected. For gravel site pass #9, a weak condensate vapour plume is detected.

The following section details the results of each pass of the grassy leak site by the realSens™ instrument. In total, there were 8 passes of this leak site, with different N₂ flow rates through the bubbler (therefore different evaporation rates). Table 3 lists the results of this test:

TABLE 3
Results of Each Pass of the Grassy Leak Site

| | | N₂ Flow | Condensate | |
|---|---|---|---|---|
| | | Rate | Evaporation Rate | |
| Pass # | Time | (scfh) | (lpm, liquid) | Detected |
| 1 | 14:25 | 240 | 0.113 | yes |
| 2 | 14:27 | 100 | 0.047 | hint |
| 3 | 14:30 | 500 | 0.235 | yes |
| 4 | 14:33 | 540 | 0.235 | yes |
| 5 | 14:35 | 300 | 0.140 | yes |
| 6 | 14:38 | 300 | 0.164 | yes |
| 7 | 14:40 | 600 | 0.282 | yes |
| 8 | 14:43 | 575 | 0.270 | yes |

An evaporated condensate plume was detected on every pass. However, the pass with the lowest evaporation rate was only a hint of detection, and under a nominal analysis would not have been flagged, as the anomaly was small and not very evident within the surrounding signals. For grass site pass #1, a strong condensate vapour plume is detected. For grass site pass #2, a hint of a condensate vapour plume is detected. For grass site pass #3, a very strong condensate vapour plume is detected. For grass site pass #4, a strong condensate vapour plume is detected. For grass site pass #5, a very strong condensate vapour plume is detected. For grass site pass #6, a small condensate vapour plume is detected. For grass site pass #7, a very strong condensate vapour plume is detected. For grass site pass #8, a small condensate vapour plume is detected.

During each pass over the leak site, the reduction in the weight of the bubbler was measured as well as the time that the flow of N₂ was turned on. Using these numbers, the rate of condensate evaporation could be determined in kg/min. Unfortunately, during the first part of the test flights the weight scale which weighed the evaporator and condensate did not work properly. As such, the change in weight of the system was only recorded in 9 of 17 passes. However, evaporation rate are a function of the N₂ flow rate into the bubbler. FIG. 2.6-1 shows the 9 measured condensate evaporation rates (g/min) as a function of the N₂ gas flow rate. The line of best fit (red) has a slope of 0.294 g min⁻¹ scfh⁻¹ and an R² of 0.75. Assuming that the density of condensate is similar to that of pentane (0.626 kg/l, a low estimate for condensate), the evaporation/leak rate for the liquid condensate could be calculated. The results of these calculations are listed in the fourth columns of Tables 2.4-1 and 2.5-1.

On Sep. 13, 2012 between 14:00 and 14:45, Synodon performed a series of experiments with its realSens™ remote sensing technology to test its ability to detect leaks of natural gas condensates at the request of Keyera Corp. These tests were performed 65 km West of Calgary and over two representative surface types, over-grown gravel and grass. Condensate leaks were simulated by evaporating condensate into a Nitrogen (N₂) gas stream, using an evaporator system. Estimates of the evaporation rates (lpm, liquid) were made by measuring the change (loss) of weight of the system. In total 9 overflight passes of the gravel site and 8 overflight passes of the grass site were flown, at various N₂ flow rates. Condensate evaporation rates for these tests ranged from 47 ml/min to 280 ml/min (liquid). Of the 17 passes, 16 condensate plumes were detected or 94%. Winds on this day were high, 20 km/h with gusts to >35. This resulted in turbulent mixing of the plumes, often producing “chopped up” gas plumes, as was seen in this data. However, even with the high winds, the smallest detected condensate plume was the smallest rate tested, 47 ml/min.

These test are the third flight tests of liquid hydrocarbons leak detection with the realSens™ technology and the first with natural gas condensates. The results of the tests shows realSens™ has a strong ability to detect leaks of condensates.

A person skilled in the art could make immaterial modifications to the invention described in this patent document without departing from the invention.

The embodiments of the invention in which an exclusive property or privilege is claimed are defined as follows:

1. A method of detecting a leak of a hydrocarbon liquid, the method comprising the steps of:
traversing a target area with a gas filter correlation radiometer having a field of view oriented towards the target area, the gas filter correlation radiometer comprising a gas correlation cell containing a gas having a spectral band overlapping a spectral band of a vapour of the hydrocarbon liquid, and
identifying a liquid leak upon the gas filter correlation radiometer detecting the vapour of the hydrocarbon liquid.

2. The method of claim 1 in which the gas contained in the gas correlation cell is ethane.

3. The method of claim 1 in which the spectral band of the vapour of the liquid is a spectral band of pentane.

4. A method of detecting a leak of a hydrocarbon liquid, the hydrocarbon liquid having a vapour, the method comprising the steps of: traversing a target area with a gas filter correlation radiometer having a field of view oriented towards the target area, the gas filter correlation radiometer comprising a gas correlation cell containing a gas present in the vapour of the hydrocarbon liquid; and
identifying a liquid leak upon the gas filter correlation radiometer detecting the gas.
